(19) United States
(12) Patent Application Publication
(10) Pub. No.: US 2022/0279961 A1
(43) Pub. Date: Sep. 8, 2022

(54) A COOKING VESSEL AND A METHOD OF PRODUCING THE SAME

(71) Applicant: CANIEL INDUSTRY A.T.G LTD., KFAR DABA (IL)

(72) Inventors: TAL LEIZER, ZIKHRON YAACOV (IL); ARIE GABAY, RAANANA (IL); LIOR YEMINI, SHOHAM (IL); OFFER ABRAMOVITCH, GIVAT ADA (IL); MENAHEM SALAN, RISHON LEZION (IL); OFER TALMON, KFAR SABA (IL); ORI PERSKY, RAMAT HASHARON (IL); PAVEL GORODNITSKY, MODI'IN (IL); ORIT TALMON, KFAR SABA (IL)

(21) Appl. No.: 17/633,231

(22) PCT Filed: Aug. 4, 2020
(86) PCT No.: PCT/IL2020/050850

§ 371 Date: Feb. 7, 2022

(30) Foreign Application Priority Data
Aug. 13, 2019 (IL) 268692

(51) Int. Cl. A47J 36/02; A47J 45/06; B21D 51/22

(52) U.S. Cl. CPC A47J 36/02; A47J 45/06; B21D 51/22

(57) ABSTRACT

A cooking vessel, comprising a base, having an upper surface and a bottom surface, wherein the upper surface is configured to be in contact with food cooked inside the cooking vessel, sidewalls extending from the base, at the direction of the upper surface, said sidewalls have an internal surface configured to be in contact with food cooked inside the cooking vessel, wherein the base and the sidewalls are made of at least one metallic material sheets, wherein the base and the sidewall are connected by welding or folding, wherein the internal surface of the sidewalls and the upper surface of the base are coated by a coating layer configured to prevent degradation of the at least one metallic material sheets when heating the cooking vessel.

### FIELD OF THE INVENTION

The present invention relates to cooking vessels and a method of producing the same.

### BACKGROUND OF THE INVENTION

Cooking vessels are used to heat or otherwise process food to a desired condition. Some cooking vessels are configured to be mounted on direct fire, while other cooking vessels are configured to be placed inside ovens. The cooking vessels may be made of metals, such as steel, aluminum and others, or by non-metalic and heat-resistance materials, such as clay. Cooking vessels may be cooking pots, baking pans or other containers that have at least a base and sidewall that prevent leakage of materials while cooking and are heat-resistance.

When cooking outdoor, or when wishing to cook and/or carry food, some users prefer to use disposable cooking vessels, which can be put in the trash can after use. The disposable cooking vessels are required to be manufactured at a low cost, in order to be attractive in the market. The low cost may be defined as end used price in the range of 0.2-0.5 US dollars per cooking vessel in the store. The business requirement to produce the cooking vessels at very low costs limits the technical usage of the disposable cooking vessels. For example, some disposable cooking vessels are made of thin aluminum sheets. These disposable cooking vessels may be used for baking a cake, but cannot be used for cooking in higher temperatures or for longer hours or on direct fire or heat source, as the aluminum will melt into the cooked food. Thus, there is a need for disposable cooking vessels enabled to be heat at high temperatures, such as 150-200 degrees Celsius, for more than 30 minutes, at a reasonable end user price.

### SUMMARY OF THE INVENTION

It is an object of the subject matter to disclose a cooking vessel, comprising a base, having an upper surface and a bottom surface, wherein the upper surface is configured to be in contact with food cooked inside the cooking vessel, sidewalls extending from the base, at the direction of the upper surface, said sidewalls have an internal surface configured to be in contact with food cooked inside the cooking vessel, wherein the base and the sidewalls are made of at least one metallic material sheets, wherein the base and the sidewall are connected by welding or folding, wherein the internal surface of the sidewalls and the upper surface of the base are coated by a coating layer configured to prevent degradation of the at least one metallic material sheets when heating the cooking vessel.

In some cases, the sidewalls and the base are made of tinplate. In some cases, the coating layer comprises lacquer coated on the internal surface of the sidewalls and the upper surface of the base.

In some cases, the coating layer comprises an epoxy material coated on the internal surface of the sidewalls and the upper surface of the base. In some cases, the epoxy material is present in the cooking vessel in the range of 5-30 grams per square meters of the sidewall and base sheet when dry. In some cases, the coating layer comprises Trimethoxy(methyl)silane. In some cases, the coating layer comprises Isopropyl alcohol. In some cases, the sidewalls are shaped by an expender machine.

In some cases, the cooking vessel further comprises a housing connected to the base, said housing is configured to secure a bottom section of the sidewall, wherein the housing is located higher than the base. In some cases, the sidewalls have a first slope in a first section of the sidewall and a second slope in a second section of the sidewall. In some cases, the cooking vessel further comprises a pair of handles located on two distinct sections of the sidewalls. In some cases, the pair of handles are located at the top section of the sidewall.

It is an object of the subject matter to disclose a cooking vessel, manufactured by a process, said process comprising obtaining a sheet of at least one metallic material, cutting the sheet of at least one metallic material to a base sheet and a sidewall sheet, rolling the sidewall sheet to correspond to the base sheet, attaching the sidewall sheet and the base sheet, coating the sidewall sheet and the base sheet. In some cases, the process further comprises manufacturing a lid for the cooking vessel, the lid is configured to cover a volume defined by the base and sidewall, said lid is shaped to cover an entire top section of the sidewall sheet. In some cases, the coating comprises applying a lacquer on at least a portion of the sidewall sheet and the base sheet.

It is an object of the subject matter to disclose a process for manufacturing a cooking vessel, comprising obtaining a sheet of at least one metallic material, cutting the sheet of at least one metallic material to a base sheet and a sidewall sheet, rolling the sidewall sheet to correspond to the base sheet, attaching the sidewall sheet and the base sheet, coating the sidewall sheet and the base sheet. In some cases, the process further comprises manufacturing a lid for the cooking vessel, the lid is configured to cover a volume defined by the base and sidewall, said lid is shaped to cover an entire top section of the sidewall sheet. In some cases, the coating comprises applying a lacquer on at least a portion of the sidewall sheet and the base sheet.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a cooking vessel having a lid and handles, according to exemplary embodiments of the present invention;

FIGS. 2A-2B show multiple cooking vessels stacked on each other, according to exemplary embodiments of the present invention;

FIG. 3 shows a cross section of stacked multiple cooking vessels with sidewalls having two different slopes, according to exemplary embodiments of the subject matter;

FIG. 4 shows a base of a cooking vessel, according to exemplary embodiments of the subject matter;

FIG. 5 shows a method for manufacturing a cooking vessel, according to exemplary embodiments of the present invention; and,

FIG. 6 shows a method for manufacturing a cooking vessel by coating the metallic sheet before welding/rolling, according to exemplary embodiments of the present invention.

### DETAILED DESCRIPTION OF THE INVENTION

The subject matter discloses a cooking vessel manufactured in a process for manufacturing cans. The cooking vessel comprises a metal base and metal sidewalls, produced from a sheet of material that is commonly used to manufacture cans. Manufacture of the cooking vessel in a manufacture facility and utilizing machinery of manufacturing cans enable to reduce the price for the end user on the shelf, thus enabling to produce a disposable cooking vessel which is heat resistant. The process of manufacturing the cooking vessel is disclosed in detail below. The cooking vessel may be designed in a manner that enables stacking multiple cookng vessels one on top of the other. The cooking vessel is coated by a coating layer that enables to expose the cooking vessel to high temperatures, without degradation of the metal into the food.

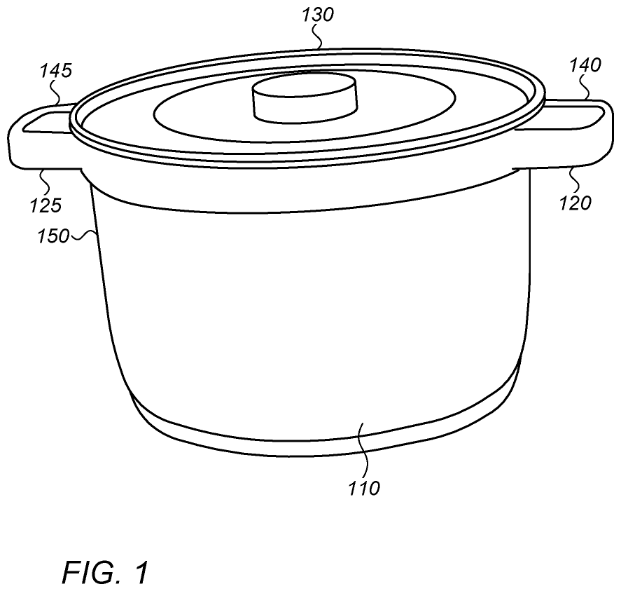

FIG. 1 shows a cooking vessel having a lid and handles, according to exemplary embodiments of the present invention. The cooking vessel comprises a base (not shown) and sidewalls 110. The sidewalls 110 extend upwards from the base. The term upwards is defined as the direction closer to the upper surface of the base, where the food is configured to be placed. The base and the sidewalls are made of the same material, used to manufacture cans. Such material may be tinplate. The material may be any rigid material that comprises, at least partially, metals. The material is coated before cut by a machine and shaped as the base and the sidewalls 110. In some cases, the coating may be performed after the cut by the machine.

The cooking vessel comprises a lid 130 configured to be placed on top of the sidewalls 110, preventing passage of gas and liquid into and out of the inner volume of the cooking vessel. The inner volume is the volume between the sidewalls 110 and the base. The lid 130 may be shaped to cover an entire top section of the sidewall sheet.

The shape of the sidewalls 120 enables stacking multiple cooking vessels one on top of the other in a manner that consumes less volume. For example, the handles 120, 125 may be located very close to the upper surface 150 of the sidewalls 110. In some cases, the distance between the upper ends 140, 145 of the handles 120, 125 and the upper surface 150 may be in the range of 0.5-5 millimeters. The handles 120, 125 may be coated on two distinct sections of the sidewalls 110.

In an alternative definition, the handles 120, 125 may consume less than 5%-8% of the height of the sidewalls 110, as the height is defined between the base and the upper surface 150. This way, a pack of 10 stacked cooking vessels has a height of 2 cooking vessels, which enables placing the stack on a store's shelf in a very economic and efficient manner.

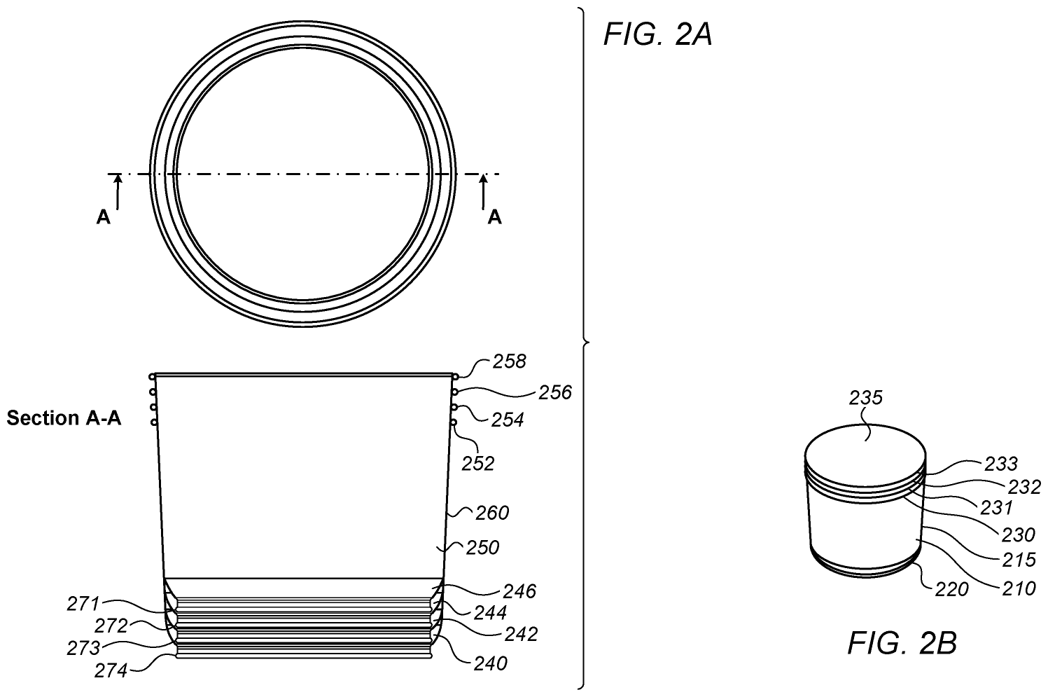

FIGS. 2A-2B show multiple cooking vessels stacked on each other, according to exemplary embodiments of the present invention. The stacked cooking vessels lack handles. FIG. 2A shows a cross section of the stacked multiple cooking vessels. In the example of FIG. 2A, the stack comprise four (4) cooking vessels, each of the cooking vessel is defined by a base and sidewalls. The four bases 240, 242, 244 and 246 are made of a metal compound. The upper surface of the bases 240, 242, 244 and 246 is coated in order to enable exposure of the metal compound to high temperatures or for longer surations, without a portion of the metal compound separating from the base and mixed with the food while cooked.

The sidewalls 260 of the cooking vessels have an inner surface 250 being in contact with the food and an external surface. When the cooking vessel comprises handles, the handles are affixed to the external surface of the cooking vessel. The sidewalls 260 may be processed from the same sheet of material used to manufacture the bases 240, 242, 244 and 246. In some other cases, the sidewalls 260 may be manufactured from a material different from the material used to manufacture the bases 240, 242, 244 and 246. The sidewalls 260 have an elliptical shape, for example an ellipse or circle. The upper surfaces 252, 254, 256, 258 of the sidewalls of the four cooking vessels may be extended and curved outwards. That is, upper surface 252 is the distal end of the sidewalls extending from the base 240, upper surface 254 is the distal end of the sidewalls extending from the base 242, upper surface 256 is the distal end of the sidewalls extending from the base 244, and upper surface 258 is the distal end of the sidewalls extending from the base 246.

The sidewalls are shaped to form a slope, such that the area of the base is smaller than the imaginary area defined between the sidewalls of each of the cooking vessels. This way, one cooking vessel can be inserted from the upper surface of the next cooking vessel, and the top surface of the base 242 is very close, or even in physical contact, with the upper surface of the vase 240. The slope's angle may be in the range of 0.5-8 degrees.

Each of the sidewalls have a bottom portion, located near the bases. Bottom portion 271 is connected to the base 246, bottom portion 272 is connected to the base 244, bottom portion 273 is connected to the base 242 and bottom portion 274 is connected to the base 240. The bottom portions 271, 272, 273 and 274 are rolled outwards from the sidewalls. In the exemplary embodiment shown in FIG. 2A, the bottom portions 271, 272, 273 and 274 are lower than the bottom surface of the bases. That is, when mounting the cooking vessels on a straight surface, such as a table, the bottom portions 271, 272, 273 and 274 are in physical contact with the straight surface, not the bases.

FIG. 2B shows the multiple stacked cooking vessels. The multiple bases 220 are shown below the sidewalls 210. The slope of the sidewalls 210 is shown in the line 215. The upper surfaces 230, 231, 232, 233 are equivalent to the upper surfaces of FIG. 2A. inner surface 235 of the upper cooking vessel is configured to be in contact with the cooked food. The inner surface 235 is coated by a coating layer detailed below. The external surface of the sidewalls may be coated. In some cases, the external surface of the sidewalls is not coated.

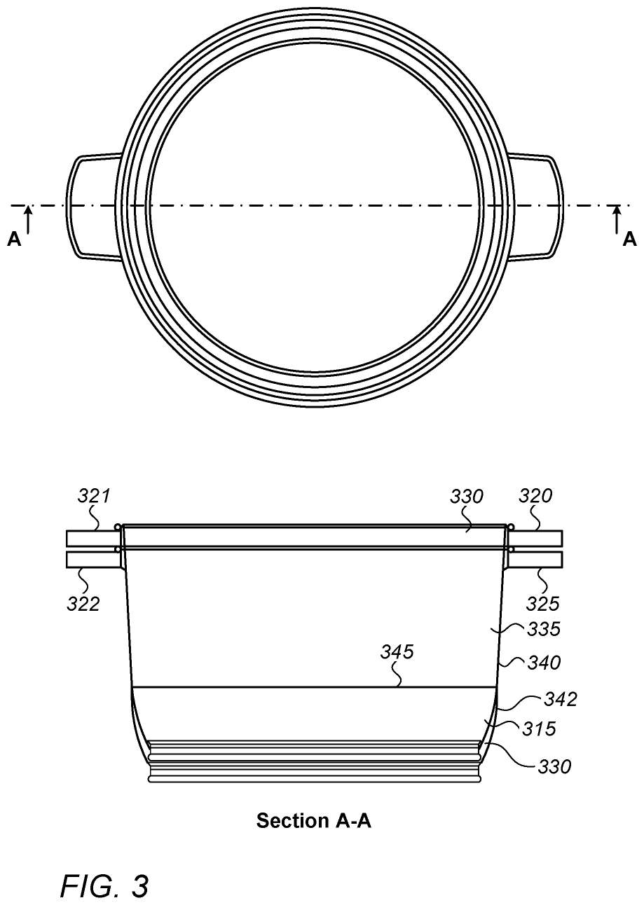

FIG. 3 shows a cross section of stacked multiple cooking vessels with sidewalls having two different slopes, according to exemplary embodiments of the subject matter. The stack of FIG. 3 shows two (2) cooking vessels, having two bases 310, 315. The base 310 is connected to sidewall 335 and the base 315 is connected to sidewall 330. Both sidewalls 330 and 335 have substantially the same shape. The shape of the sidewalls 330 and 335 has two slopes—the first slope is between the bases 310, 315 and horizontal line 345 and the second slope is between the horizontal line 345 to the upper end of the sidewalls 330, 335. In some exemplary cases, the vertical angle of the first slope is bigger than the vertical angle of the second slope. The vertical angle is defined between the vertical axis of the cooking vessels and the sidewalls. For example, in FIG. 3, the vertical angle of the first slope may be in the range of 2-8 degrees and the the vertical angle of the second slope may be in the range of 5-18 degrees.

Each of the cooking vessels of FIG. 3 has a pair of handles configured to hold the cooking vessel. The handles enable more solid and secure holding of the cooking vessel. The handles may also be used to isolate heat from the cooking vessel, according to the properties of the handles. The sidewall 330 is connected to handles 320 and 321 and the sidewall 335 is connected to handles 322 and 325. In some exemplary cases, the height of the sidewalls is in the range of 1-70 centimeters. The height of the handles, defined between the top surface and the bottom surface of the handles, may be in the range of 1-170 millimeters, enabling efficient stacking of a stack of multiple cooking vessels.

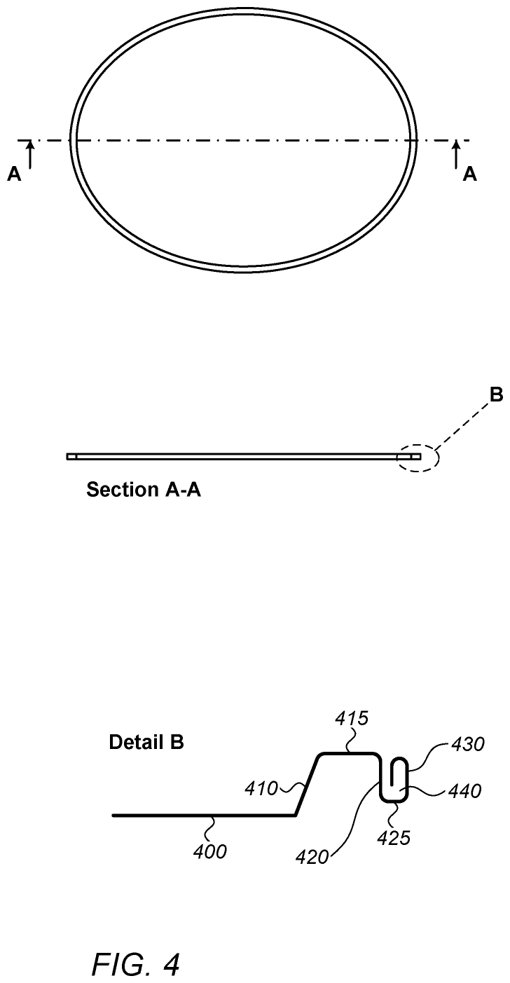

FIG. 4 shows a base of a cooking vessel, according to exemplary embodiments of the subject matter. The structure of the cooking vessel as shown in FIG. 4 enables to mount the base directly on a flat heating medium, such as electrical stove top. The cooking vessel comprises a base 400 having a bottom surface that can be mounted on the stove top and an upper surface on which the food is configured to be placed. The base 400 is connected to a housing 440 used to accommodate the bottom portion of the sidewalls. The housing 440 may surround the entire base 400, or a portion of the base 400. The base 400 is connected to the housing 440 by a protrusion member 410 extending upwards from the base 400. The height of the protrusion member 410 may be in the range of 0.1-20 millimeters, or have a height desired by a person skilled in the art. Transfer of heat from the heating source to the cooking vessel may be enabled due to the flat or substantially flat bottom surface of the vase 400. The protrusion member 410 is connected to lateral member 415, which extends laterally and outwards form the center of the base 400. The housing 440 is located in the distal side of the lateral member 415, away from the base 400. The housing 440 may be formed by a rolled metal sheet having a proximal side 420 connected to the lateral member 415, a bottom side 425 and a distal side 430. The bottom side 425 is connected to both the proximal side 420 and the distal side 430, forming a pocket into which the bottom section of the sidewalls may be inserted. As the bottom side 425 is higher than the base 400, the base 400 is the most bottom section of the cooking vessel, and therefore can be placed directly on the stove. It should be noted that all the base elements, including the base 400, the protrusion member 410, the lateral member 415, the bottom side 425, the proximal side 420 and the distal side 430 may be formed from the same sheet of material. Such material may be the material used to manufacture cans, such as tinplate.

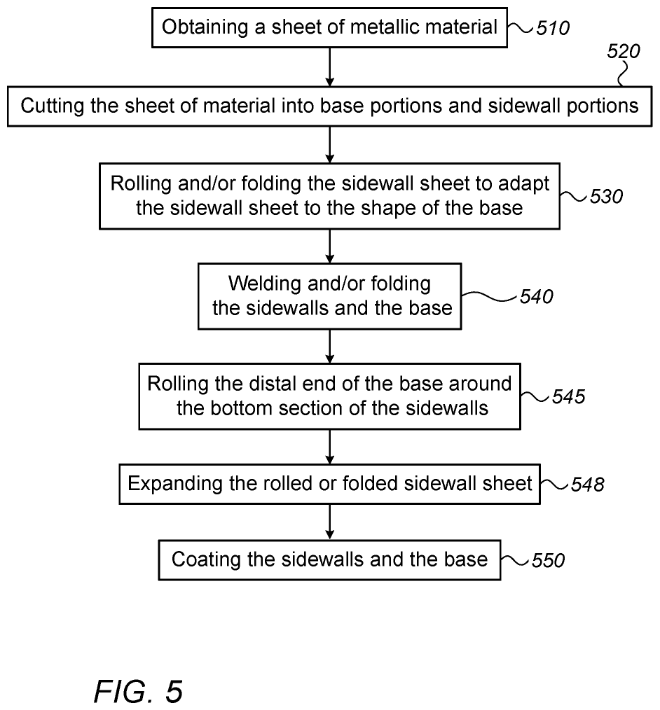

FIG. 5 shows a method for manufacturing a cooking vessel, according to exemplary embodiments of the present invention.

Step 510 discloses obtaining a sheet of at least one metallic material. The metallic material may be coated by tin. The metallic material may comprise tinplate, chromium, a combination of tinplate and chromium, a derivative of at least one of tinplate or chromium and a material having physical or chemical characteristics of tinplate or chromium. The width of the sheet of material may be in the range of 0.1-1.5 millimeters.

Step 520 discloses cutting the sheet of material into base portions and sidewall portions. The base portions may be circular. The sidewall portions may be rectangular, as one side of the rectangular sheets forming the sidewalls has a length that corresponds to the circumference of the base sheet. The sheet of material may undergo a printing process on a side of the sheet used as an external side of the cooking vessel.

Step 530 discloses rolling the sidewall sheet to adapt the sidewall sheet to the shape of the base. After rolling, the sidewall sheet has a substantially cylindrical shape.

In some exemplary cases, the manufacturing method also comprises step 540 of rolling the distal end of the base around the bottom section of the sidewalls. Step 545 discloses welding and/or folding the sidewalls and the base. After welding and/or folding, the sidewalls and the base form an integral member, having the final shape of the cooking vessel to form a cooking vessel having a base directly placed on a stove, as shown in FIG. 4. Step 548 discloses expanding the rolled sidewall sheet. After the expanding process, the lateral cross section of the sidewalls of the cooking vessel is of a desired shape, as shown in FIGS. 2 and 3. The desired shape may include multiple slopes, a step, a conic shape and the like.

Step 550 discloses coating the sidewalls and the base. In some exemplary cases, the coating is applied only on the internal surface of the sidewalls and the top surface of the base, which are in contact with the food. The coating is of a manner that enables heating the cooking vessel at high temperatures, or for longer periods. For example, the cooking vessel reaches a temperature of 200° C. Coating may be performed by spraying the coating material onto the side of the sheet of material used as an internal sidewall of the cooking vessel.

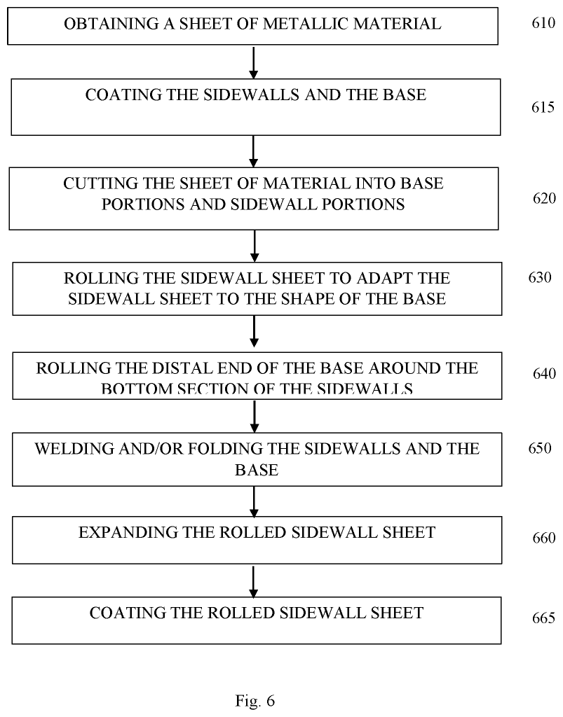

FIG. 6 shows a method for manufacturing a cooking vessel by coating the metallic sheet before welding/rolling, according to exemplary embodiments of the present invention.

Step 610 discloses obtaining a sheet of at least one metallic material. The metallic material may be coated by tin. The metallic material may comprise tinplate, chromium, a combination of tinplate and chromium, a derivative of at least one of tinplate or chromium and a material having physical or chemical characteristics of tinplate or chromium. The width of the sheet of material may be in the range of 0.1-1.5 millimeters.

Step 615 discloses coating the sidewalls and the base. In some exemplary cases, the coating is applied only on the internal surface of the sidewalls and the top surface of the base, which are in contact with the food. The coating is of a manner that enables heating the cooking vessel at high temperatures, or for longer periods. For example, the cooking vessel reaches a temperature of 200° C. When coating is performed prior to cutting the sheet of material, coating may be performed by printing the coating material onto the sheet of material. The printing may be performed on both sides of the sheet of at least one metallic material. On one side of the sheet of at least one metallic material, the printed material is required to be approved in the food industry. On another side of the sheet of at least one metallic material, the printed material is not required to be approved in the food industry.

Step 620 discloses cutting the sheet of material into base portions and sidewall portions. The base portions may be circular. The sidewall portions may be rectangular, as one side of the rectangular sheets forming the sidewalls has a length that corresponds to the circumference of the base sheet.

Step 630 discloses rolling the sidewall sheet to adapt the sidewall sheet to the shape of the base. After rolling, the sidewall sheet has a substantially cylindrical shape.

In some exemplary cases, the manufacturing method also comprises step 640 of rolling the distal end of the base around the bottom section of the sidewalls.

Step 640 discloses welding and/or folding the sidewalls and the base. After welding and/or folding, the sidewalls and the base form an integral member, having the final shape of the cooking vessel to form a cooking vessel having a base directly placed on a stove, as shown in FIG. 4. Step 660 discloses expanding the rolled sidewall sheet. After the expanding process, the lateral cross section of the sidewalls of the cooking vessel is of a desired shape, as shown in FIGS. 2 and 3. The desired shape may include multiple slopes, a step, a conic shape and the like. Step 665 discloses coating the rolled sidewall sheet. Step 665 provides for a secondary coating process performed in order to verify that the entire cooking vessel is coated. The secondary coating may be performed to the entire cooking vessel. The secondary coating may be performed to a portion of the cooking vessel, based on detection that the portion is not coated properly.

The amount of coating applied on the cooking vessel may be in the range of 1-70 grams per cooking vessel. In some exemplary embodiments, the amount of coating is measured per area of the sidewalls and base, for example the coating layer has a weight of 5-25 grams per square meter of the surface of the sidewall sheet and the base sheet.

The coating layer may comprises one or more layers. An example of a single layer may be a coating layer made of Trimethoxy(methyl)silane. In some exemplary cases, the single layer may be made of a combination of Trimethoxy(methyl)silane and Acetic acid. In some exemplary cases, the Acetic acid may be present in the coating layer in 0.1-5% by weight of the coating layer. An example of a single layer may be a coating layer made of Isopropyl alcohol.

In some exemplary cases, the coating layer may comprises two or more layers. In some exemplary cases, one of the two or more layers is made of enamel. The two or more layers may comprises different compositions. In some cases, one layer is applied on the base sheet after the previous layer is already dried. In some exemplary cases, the sidewall sheet and the base sheet have the same coating. In some exemplary cases, the sidewall sheet and the base sheet have a different coating. In some cases, the coating layer comprises an epoxy material.

The coating layer may be any type of coating approved in the food industry. The coating may comprise lacquer, lac-based finishes or varnish. The coating layer may be polymers dissolved in volatile organic compounds (VOCs), such as nitrocellulose, and later acrylic compounds dissolved in lacquer thinner, a mixture of several solvents typically containing butyl acetate and xylene or toluene. The coating layer may comprise Nitrocellulose lacquers, Acrylic lacquers, Water-based lacquers and a combination thereof.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A cooking vessel, comprising:
a base, having an upper surface and a bottom surface, wherein the upper surface is configured to be in contact with food cooked inside the cooking vessel;
sidewalls extending from the base, at the direction of the upper surface, said sidewalls have an internal surface configured to be in contact with food cooked inside the cooking vessel;
wherein the base and the sidewalls are made of at least one metallic material sheets;
wherein the base and the sidewall are connected by welding or folding;
wherein the internal surface of the sidewalls and the upper surface of the base are coated by a coating layer configured to prevent degradation of the at least one metallic material sheets when heating the cooking vessel.

2. The cooking vessel of claim 1, wherein the sidewalls and the base are made of tinplate.

3. The cooking vessel of claim 1, wherein the coating layer comprises lacquer coated on the internal surface of the sidewalls and the upper surface of the base.

4. The cooking vessel of claim 1, wherein the coating layer comprises an epoxy material coated on the internal surface of the sidewalls and the upper surface of the base.

5. The cooking vessel of claim 4, wherein the epoxy material is present in the cooking vessel in the range of 5-30 grams per square meters of the sidewall and base sheet when dry.

6. The cooking vessel of claim 1, wherein the coating layer comprises Trimethoxy(methyl)silane.

7. The cooking vessel of claim 1, wherein the coating layer comprises Isopropyl alcohol.

8. The cooking vessel of claim 1, wherein the sidewalls are shaped by an expender machine.

9. The cooking vessel of claim 1, further comprises a housing connected to the base, said housing is configured to secure a bottom section of the sidewall, wherein the housing is located higher than the base.

10. The cooking vessel of claim 1, wherein the sidewalls have a first slope in a first section of the sidewall and a second slope in a second section of the sidewall.

11. The cooking vessel of claim 1, further comprises a pair of handles located on two distinct sections of the sidewalls.

12. The cooking vessel of claim 8, wherein the pair of handles are located at the top section of the sidewall.

13. A cooking vessel, manufactured by a process, said process comprising:
obtaining a sheet of at least one metallic material;
cutting the sheet of at least one metallic material to a base sheet and a sidewall sheet;
rolling the sidewall sheet to correspond to the base sheet;
attaching the sidewall sheet and the base sheet;
coating the sidewall sheet and the base sheet.

14. The cooking vessel of claim 13, wherein the process further comprises manufacturing a lid for the cooking vessel, the lid is configured to cover a volume defined by the base and sidewall, said lid is shaped to cover an entire top section of the sidewall sheet.

15. The cooking vessel of claim 13, wherein the coating comprises applying a lacquer on at least a portion of the sidewall sheet and the base sheet.

16. A process for manufacturing a cooking vessel, comprising:
obtaining a sheet of at least one metallic material;
cutting the sheet of at least one metallic material to a base sheet and a sidewall sheet;
rolling the sidewall sheet to correspond to the base sheet;
attaching the sidewall sheet and the base sheet;
coating the sidewall sheet and the base sheet.

17. The process of claim 16, wherein the process further comprises manufacturing a lid for the cooking vessel, the lid is configured to cover a volume defined by the base and sidewall, said lid is shaped to cover an entire top section of the sidewall sheet.

18. The process of claim 16, wherein the coating comprises applying a lacquer on at least a portion of the sidewall sheet and the base sheet.

19. The process of claim 16, wherein the coating is performed prior to curring the sheet of at least one metallic material.

20. The process of claim 19, further comprises coating the rolled sidewall sheet.

21. The process of claim 16, further comprises shaping the sidewalls by an expender machine.
